(19) United States
(12) Patent Application Publication
(10) Pub. No.: US 2011/0145741 A1
(43) Pub. Date: Jun. 16, 2011

(54) Context Specific X-ray Imaging User Guidance System

(75) Inventor: Prabhakant Das, Streamwood, IL (US)

(73) Assignee: SIEMENS MEDICAL SOLUTIONS USA, INC., Malvern, PA (US)

(21) Appl. No.: 12/878,047

(22) Filed: Sep. 9, 2010

Related U.S. Application Data
(60) Provisional application No. 61/286,862, filed on Dec. 16, 2009.

(51) Int. Cl. G06F 3/048

(52) U.S. Cl. 715/764

(57) ABSTRACT

A medical imaging device user interface system includes an acquisition processor for automatically acquiring subunit state data representing operational state of multiple individual subunits of a medical imaging system. At least one repository of state information identifies, next operational system states accessible from a current operational state, actions needed to transition from a current operational state to a next individual operational state and operational system states inaccessible from a current operational state. An operational state processor uses the acquired subunit state data and the state information for, identifying a current operational state of a medical imaging system, determining operational system states accessible from the identified current operational state and actions needed to transition from the identified current operational state to a next individual operational state and identifying operational system states inaccessible from a current operational state.

This is a non-provisional application of provisional application Ser. No. 61/286,862 filed 16 Dec. 2009, by P. Das.

### FIELD OF THE INVENTION

This invention concerns a user interface system supporting user operation of a medical imaging system comprising multiple subunits by determining current operational state and accessible operational state of subunits using a repository of state information.

### BACKGROUND OF THE INVENTION

A user is able to interact with known medical imaging systems in different ways. For example, a user may press a mouse button, make a selection on a touch screen, move a joystick and/or press the buttons on the joystick. However, a user needs to know from prior experience how to interact with the system to get optimal usage and performance. There are helpful hints, messages, sounds, for example, provided at different points in an imaging procedure but there are deficiencies in such operational help messages. The operational help messages lack a unified consistent format for guiding a user in making a selection from among available choices and may intermittently pop up a warning or an error message if a user does something incorrect for an imaging procedure. Also, there is rarely any indication identifying to a user what is a next correct maneuver. Further, there may be more than one way of achieving a desirable result, not all of which may be the most efficient way of achieving that desirable result at different system states and positions in time.

Known systems are typically restricted to supporting limited functions such as providing a sound or text message display or not responding to a user action at all, if a requested movement of the equipment is not possible. Known systems typically have a number of pre-programmed modes that are mutually exclusive and a user can not go from one mode to another unless a current mode is completed or cancelled. The system requires a user to choose one of these modes at the beginning of using the system. Available online help information requires that the user acquires and reads the information and is able to understand what actions to take based on what state the system is in. Determining a current system state, may be difficult for a user. In case of difficulty, a user may have to ask another more experienced user for guidance in using the equipment. Known systems that provide context-sensitive help online, for example, via a menu system, require a user to know or determine a system state and associate it with a proper context and be able to determine the next allowed steps. A system according to invention principles addresses these deficiencies and related problems.

### SUMMARY OF THE INVENTION

A user interface system is aware of its state and its capabilities in relation to tasks it allows users to perform and guides the user in making appropriate choices relevant to a current system state. A user interface system supports user operation of a medical imaging system comprising multiple subunits. The system includes an acquisition processor for automatically acquiring subunit state data representing operational state of multiple individual subunits of a medical imaging system. At least one repository of state information identifies, next operational system states accessible from a current operational state, actions needed to transition from a current operational state to a next individual operational state and operational system states inaccessible from a current operational state. An operational state processor uses the acquired subunit state data and the state information for, identifying a current operational state of a medical imaging system, determining operational system states accessible from the identified current operational state and actions needed to transition from the identified current operational state to a next individual operational state and identifying operational system states inaccessible from a current operational state.

### BRIEF DESCRIPTION OF THE DRAWING

FIG. 1 shows a user interface system supporting user operation of a medical imaging system, according to invention principles.

FIG. 2 shows an architecture and connection of elements of a user interface system supporting user operation of a medical imaging system, according to invention principles.

FIG. 3 shows modes of a medical imaging system, according to invention principles.

FIG. 4 shows a sample state machine representing states and state transitions of a medical imaging system subunit, according to invention principles.

FIG. 5 shows states of medical imaging system subunits SU1, SU2, and SU3, according to invention principles.

FIGS. 6, 7 and 8 show state machine diagrams representing states and state transitions of subunits SU1, SU2, and SU3, respectively of a medical imaging system, according to invention principles.

FIGS. 9A and 9B show the states the subunits SU1, SU2, and SU3 need to have for the medical imaging system to be in modes M1 and M2, respectively, according to invention principles.

FIG. 10 illustrates a case in which transition from one mode to another mode is not possible as determined by a user interface system, according to invention principles.

FIG. 11 shows medical imaging system operational state information presented in user understandable form by a user interface system, according to invention principles.

FIG. 12 shows a state machine diagram representing states and state transitions for a Stand Controller subunit controlling movement of an X-ray detector on a stand, according to invention principles.

FIG. 13 shows actions and/or events that cause individual subunits to transition from one step to another in the form of a topologically sorted Directed Acyclic Graph (DAG), according to invention principles.

FIG. 14 shows a flowchart of a process used by a user interface system supporting user operation of a medical imaging system, according to invention principles.

### DETAILED DESCRIPTION OF THE INVENTION

A medical imaging user interface system is aware of its state and its capabilities in relation to tasks it allows users to perform and guides a user in making appropriate choices relevant to a current system state. For example, at a certain point in a medical imaging procedure, a user desires to move an X-ray unit C-arm (hosting X-ray emitter and detector devices rotatable around patient anatomy) in one plane to a parked position. Because there is a step pending in the current procedure the system prevents the user from moving the C-arm. Instead of displaying a generic message such as ‘Operation not possible’, when the user starts to move the C-arm with the joystick or any other controlling mechanism, the system advantageously determines and indicates why the C-arm cannot be moved, and what steps the user can perform to be able to move the C-arm.

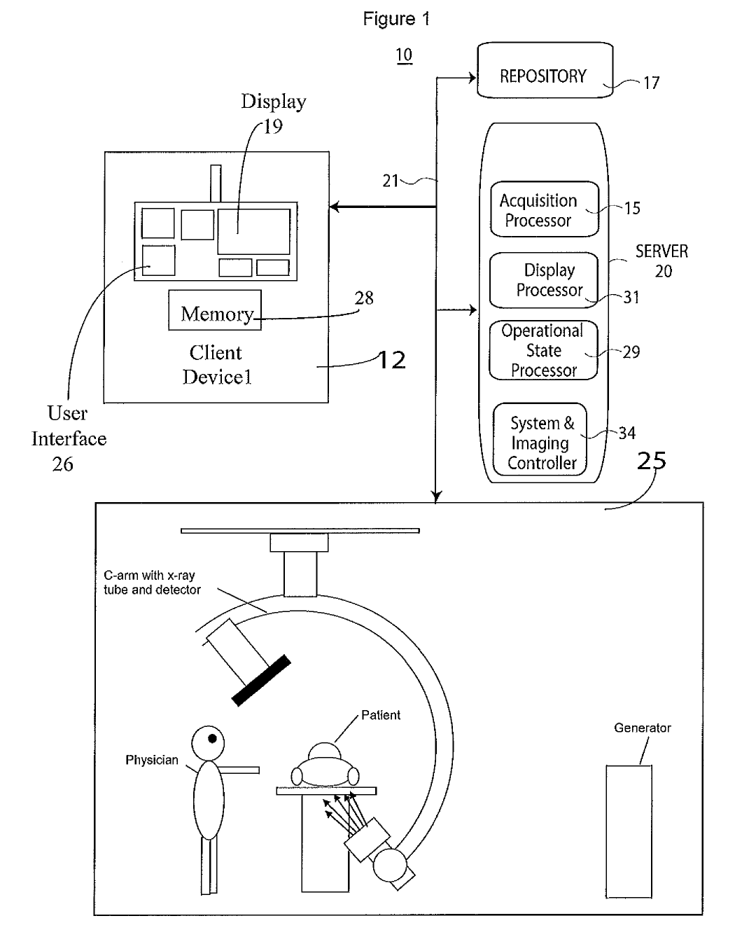

FIG. 1 shows user interface system 10 supporting user operation of a medical imaging system. System 10 includes one or more processing devices (e.g., computers, workstations or portable devices such as notebooks, Personal Digital Assistants, phones) 12 that individually include memory 28, display 19 and a user interface data entry device 26 such as a keyboard, mouse, touchscreen, voice data entry and interpretation device. System 10 also includes at least one repository 17, X-ray imaging modality system 25 (which in an alternative embodiment may comprise an MR (magnetic resonance), CT scan, or Ultra-sound system, for example) and server 20 intercommunicating via network 21. X-ray modality system 25 comprises a C-arm X-ray radiation source and detector device rotating about a patient table and an associated electrical generator for providing electrical power for the X-ray radiation system. User interface display images presented on display 19 include images generated in response to predetermined user (e.g., physician) specific preferences. At least one repository 17 stores medical image studies for multiple patients in DICOM compatible (or other) data format. A medical image study individually includes multiple image series of a patient anatomical portion which in turn individually include multiple images. At least one repository 17 also stores display images showing operational system states accessible from a current operational state and operational system states inaccessible from a current operational state.

Server 20 includes, acquisition processor 15, operational state processor 29, display processor 31 and system and imaging controller 34. Display processor 31 generates data representing display images comprising a Graphical User Interface (GUI) for presentation on display 19 of processing device 12. Imaging controller 34 controls operation of imaging device 25 in response to user commands entered via data entry device 26. In alternative arrangements, one or more of the units in server 20 may be located in device 12 or in another device connected to network 21.

Acquisition processor 15 automatically acquires subunit state data representing operational state of multiple individual subunits of a medical imaging system. At least one repository 17 includes state information identifying, next operational system states accessible from a current operational state, actions needed to transition from a current operational state to a next individual operational state and operational system states inaccessible from a current operational state. Operational state processor 29 uses the acquired subunit state data and the state information for, identifying a current operational state of a medical imaging system, determining operational system states accessible from the identified current operational state and actions needed to transition from the identified current operational state to a next individual operational state and identifying operational system states inaccessible from a current operational state.

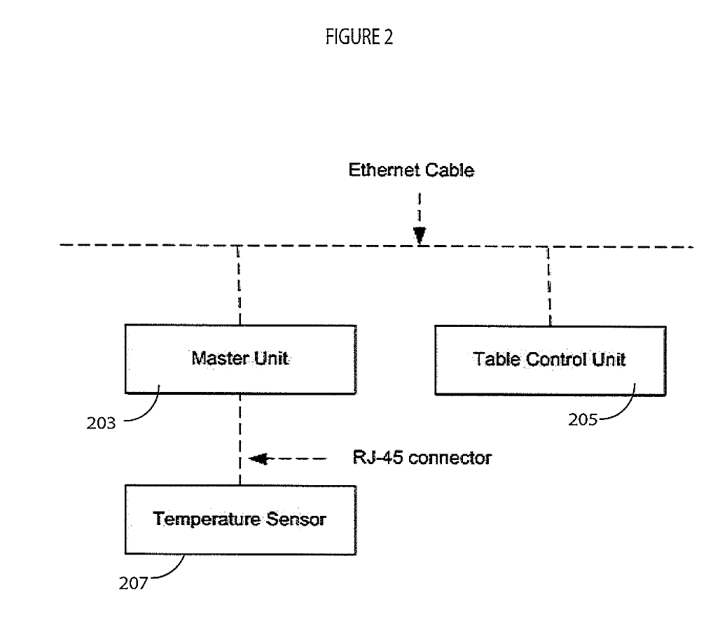

FIG. 2 shows an architecture and connection of elements of a user interface system in system 10 (FIG. 1) supporting user operation of a medical imaging system. FIG. 2 shows one of a variety of configurations and architectures by which Master unit 203 and Table Control Unit 205 are connected such as via an Ethernet network, for example. Master Unit 203 and Temperature sensors 207 are also connected directly to each other via an RJ-45 connector, for example. There are many other types of connections possible between the Master Unit and other controlling Units depending on the type of interface used for connection. Master Unit 203 makes system 10 aware of medical imaging system operational state and capabilities in different contexts and guides a user into making appropriate choices relevant to a current state and context of the system. The Master Unit 203 is ‘logically’ and/or physically connected to different standalone control units (subunits) in the medical imaging system. The stand-alone units include a C-arm, a stand control unit, a patient table side control unit and other parts used for operation of the system. Unit 203 bidirectionally communicates with the different standalone units by sending messages to (and receiving messages from) the subunits.

Master unit 203 determines the overall system state and presents this information to a user in simple English terms that are easily understandable by a non-expert, in response to messages received from different standalone units and predetermined data indicating the capabilities of the system. Unit 203 is aware of the steps that are required to be performed if a user chooses to arrive at an outcome that is different from the one previously intended and display 19 (FIG. 1) presents a user with state and operational guidance information in as much detail as needed without affecting a display area for a medical image. User interface system 10 supports user operation of different types of medical imaging system (and other types of system) without having to memorize operational steps to use system 10 efficiently and reduces time required to train a user in using the system and provides higher overall user satisfaction.

Master Unit 203 interrogates individual subunits to determine subunit status. A subunit may intermittently inform Master Unit 203 of subunit status if the status is deemed important enough to be of value to the Master Unit in determining the overall system status or state. Master Unit 203 determines the overall state of the medical imaging system in response to messages received from subunits. For example, if subunits report a status of ‘readiness’, Master Unit 203 shows this result on display 19 as well as next steps that a user may take, via a message such as:

The parts of the system are ready. You can now:

a. Do a normal acquisition.

b. Do a fluoroscopic acquisition.

c. Review a previously acquired image.

System 10 advantageously presents a user with options identifying next procedural steps that need to be taken or may be performed in a current context state of the imaging system such as for each of the options a, b, and c above, for example. In known systems in order for a user to determine options for next steps to be performed, a user typically needs to be trained in using the system. In contrast, the system presents a user with a list of activities that the user may perform associated with a current system state, status and context. Master Unit 203 constrains a list of possible modes to a minimum so that it is easier for a user to manage.

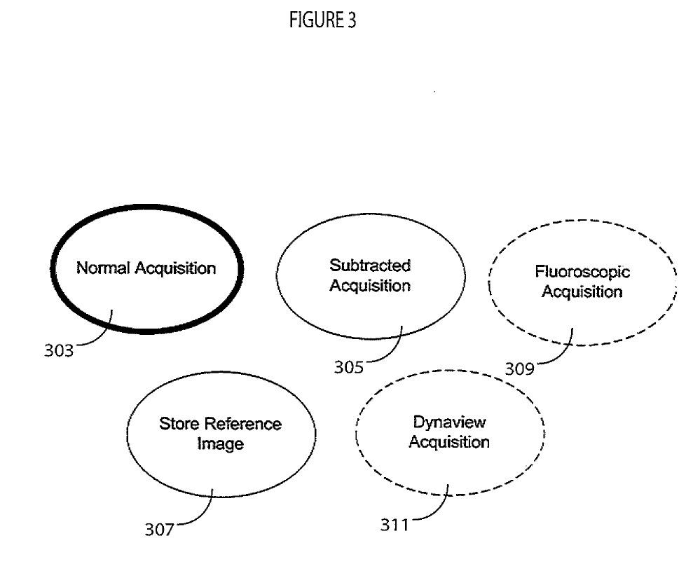

FIG. 3 shows modes of a medical imaging system in a picture display provided by master Unit 203 which shows a mode in which system 10 is operating. Oval 303 in the picture with dark boundary indicating Normal Acquisition, indicates a current system 10 state. Ovals 305 and 307 (subtracted acquisition and store reference image) with solid but thin boundaries indicate states where system 10 could transition to, from current state 303. Ovals 309 and 311 (fluoroscopic acquisition and dynaview acquisition) with broken boundary lines, denote states that are not reachable unless the current mode of Normal Acquisition is exited. If a user desires to know why a Fluoroscopic acquisition cannot be performed, the user is able to select that Fluoroscopic acquisition oval on the display and the reason the Fluoroscopic acquisition cannot be performed is presented on display 19. Since

Master Unit 203 knows the current state of the medical imaging system and has data indicating requirements to enter a Fluoroscopic Acquisition mode, unit 203 is able to present specific information indicating contextually valid reasoning to the user. For advanced users who have used the system extensively before, the system provides task-specific guidance using a comprehensive list of tasks. In response to a user selecting a specific task, the user is provided with detailed further instructions on the exact steps needed to perform the tasks based on the current state that the system is in. For example, the following are choices:

a. Move the table up.

b. Move the table down.

c. Take a fluoroscopic image.

d. Park the C-arm for plane-B,

If the user selects option a, the system shows further steps. For example, the following:

Push the red knob on the table forward.

If the system determined, however, that this step could not be performed due to some other reason, it indicates steps needed to be taken afterward. As an example, it displays the message as follows:

The table can not be moved up now.

There is a C-arm for plane B that is blocking it.

Move the C-arm for plane B to the parking position first.

System 10 is aware of its own state in relation to the tasks it helps a user to accomplish and provides guidance to the user with specific details that are valid in the context of the current system state. Specifically, system 10 provides guidance to a user enabling the user to overcome the limitations of the current state of the system is in.

Master Unit 203 (e.g., a computer) within operational state processor 29 of system 10 is in bidirectional communication with control units of the system and employs a status and help message format that the Master Unit sends, receives and interprets. Master unit 203 employs a state machine that tracks and monitors the whole medical imaging system 25 state. Operational state processor 29 interrogates predetermined information in repository 17 and control units of imaging system 25 to determine (or is automatically supplied with) data identifying the steps for performing an action. Master Unit 203 associates guidance steps with a particular system state and determines a list of action steps to achieve a user entered desired task using predetermined information stored in repository 17 indicating a comprehensive list of actions steps, and a comprehensive list of start and end states. Master Unit 203 uses predetermined information associating current system state and allowable candidate next steps and steps allowable from the candidate next steps to determine next steps to be shown to a user. In one embodiment, the system uses topological sorting in a directed acyclic graph (DAG) employing graph theory to arrive at a sequence of steps to be shown to a user.

Master Unit 203 initiates generation of display images by display processor 31 enabling a user to see a current system state, select a next specific state, see the list of action steps corresponding to the current system state and to see the reasoning for changing from one system state to another or reasoning indicating why a user selected next action is not possible from a current system state. Master Unit 203 sends query messages to medical imaging system 25 subunits and intermittently receives status messages from each of the subunits. Individual subunits initiate sending state status messages to unit 203 such as in response to a transition in state of an individual subunit, Master Unit 203 knows the state of the system 25, individual subunits and maintains a list of states that individual subunits can have as well information identifying events or actions that cause a subunit to transition from a specific state to another. Thus, Master Unit 203 for each subunit, knows a current state, the event or the action that cause a subunit to transition to a next state, as well as a specific next state. Also, Master Unit 203 associates different sets of subunits and subunit states with different overall medical imaging system 25 states.

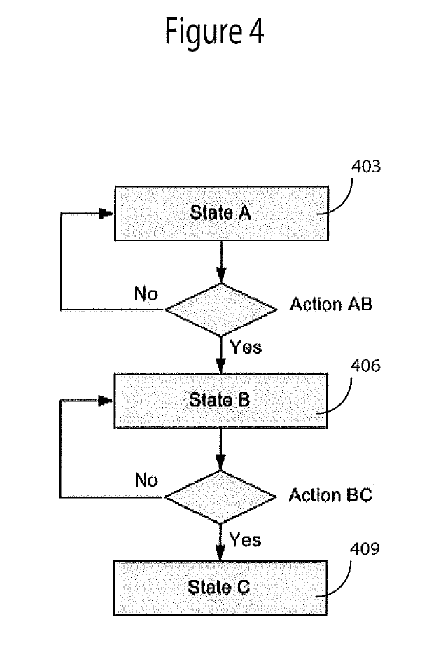

FIG. 4 shows a sample state machine known by master unit 203 and representing states and state transitions of a medical imaging system subunit. It shows three states, State A 403, State B 406 and State C 409 and two actions, Action AB and Action BC which cause state transitions from State A to State B, and from State B to State C, respectively.

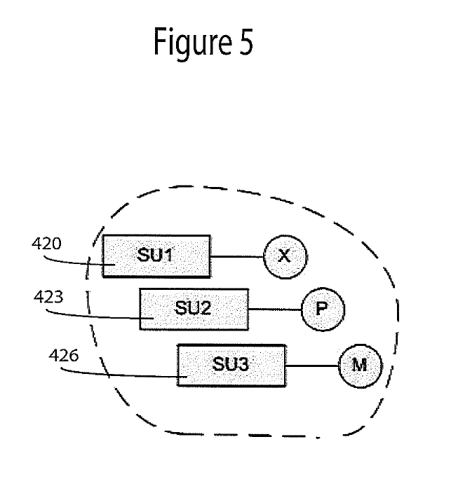

FIG. 5 shows states of medical imaging system subunits SU1, SU2, and SU3. An overall state of medical imaging system 25 comprises a collection of subunits and their associated unique states occurring at a particular time. For example, for subunits, SU1, SU2, and SU3, subunit SU1 can be in states X, Y, or Z, subunit SU2 can be in states P, Q, and R and the subunit SU3 can be in states M, N, and O. System 25 is in a state that is uniquely defined by the subunits and their corresponding states, so a system state is determined by subunits SU1 420, SU2 423, and SU3 426 being in states X, P, and M respectively, for example.

A mode that medical imaging system 25 supports is associated with a system state in which a user may perform some action to get some useful result. Thus, individual modes that system 25 supports are associated with a set containing required subunits and their corresponding states. For example, system 25 in one embodiment has modes M1 and M2.

Mode M1 has subunit states as follows:

SU1 in state X

SU2 in state Q

SU3 in state N

Mode M2 has subunit states as follows:

SU1 in state Z

SU2 in state R

SU3 in state O

FIG. 5 illustrates a system mode with SU1 in state X, SU2 in state P, and SU3 in state M. Operational state processor 29 (FIG. 1) manages system 25 state tracking and determination of allowable state transitions of a first type when state transitions remain within a single operational mode and a second type when state transitions occur between different operational modes.

In the case that state transitions remain within a single operational mode, in order to arrive at a sequence of steps for a user to perform, Master Unit 203 (FIG. 2) presents on display 19 a list of action steps that are applicable in the context derived from a list of states for the current mode stored by Master Unit 203.

Thus, if the system is in the state shown in FIG. 5, Master unit 203 displays the actions necessary on the part of a user such that the subunit SU1 stays in state X, the subunit SU2 stays in state P, and the subunit SU3 stays in state M. In the case that state transitions occur between different operational modes, in order to arrive at a sequence of steps for a user to perform, Master Unit 203 (FIG. 2) determines that a transition from one mode to another is possible when the following conditions are met,

a. The set of subunits for both the modes are the same, and

b. For each of the subunits, there is a transition possible from the state in one mode to the required state in the next mode.

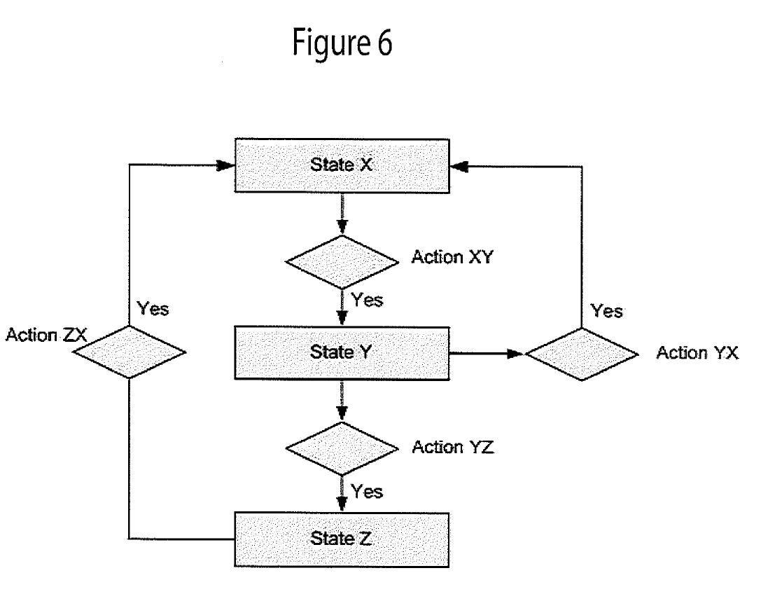

FIGS. 6, 7 and 8 show state machine diagrams representing states and state transitions of subunits SU1, SU2, and SU3, respectively of a medical imaging system and the decision diamonds represent either user activity or a message from some other subunit that causes one subunit to change state. In order to reduce clutter, only the transitions on true conditional evaluations are shown in FIGS. 6, 7 and 8. In FIG. 6, if subunit SU1 is in state X and action XY is performed, SU1 transitions to state Y and in state Y, if action YZ is performed, SU1 transitions to state Z or if action YX is performed, SU1 transitions back to state X. In state Z, if action ZX is performed, SU1 transitions to state X.

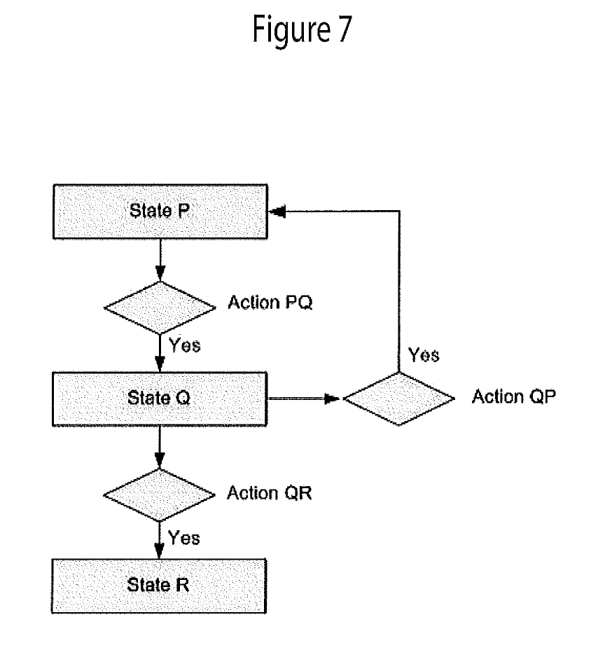

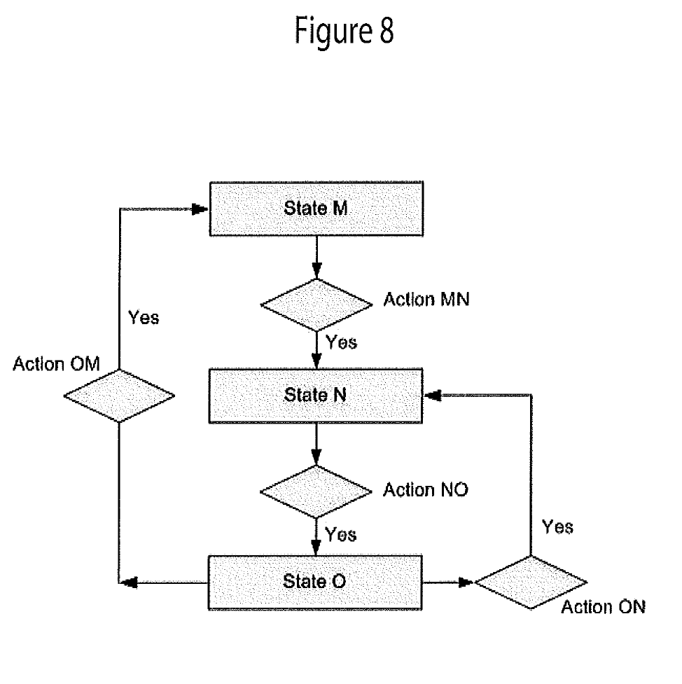

In FIG. 7, if subunit SU2 is in state P and action PQ is performed, SU2 transitions to state Q and in state Q, if action QR is performed, SU2 transitions to state R or if action QP is performed, SU2 transitions back to state P. In FIG. 8, if subunit SU3 is in state M and action MN is performed, SU3 transitions to state N and in state N, if action NO is performed, SU3 transitions to state O. In State O, if action OM is performed, SU3 transitions to state M or if action ON is performed, SU3 transitions back to state N.

In an operation example, modes M1 and M2 require subunits to be in the following states, as previously discussed.

### Mode M1:

SU1 in state X

SU2 in state Q

SU3 in state N

### Mode M2:

SU1 in state Z

SU2 in state R

SU3 in state O

When medical imaging system 25 is in mode M1, master unit 203 determines whether the system can go to mode M2 by checking whether the subunits for M1 and M2 are the same. In this example, the subunits for M1 and M2 are the same (SU1, SU2, SU3). Master unit 203 also checks whether the state transitions for each of the subunits are possible by using the state machines shown in FIGS. 6, 7 and 8. Specifically, unit 203 determines,

a. whether SU1 is able to transition from state X to state Z?

b. whether SU2 is able to transition from state Q to state R?

c. whether SU3 is able to transition from state N to state O?

The state diagrams of FIGS. 6, 7 and 8 indicate the transitions are possible for each of the subunits either after going to another state or by reaching the next state as a result of some action. Consequently transition from mode M1 to M2 is possible.

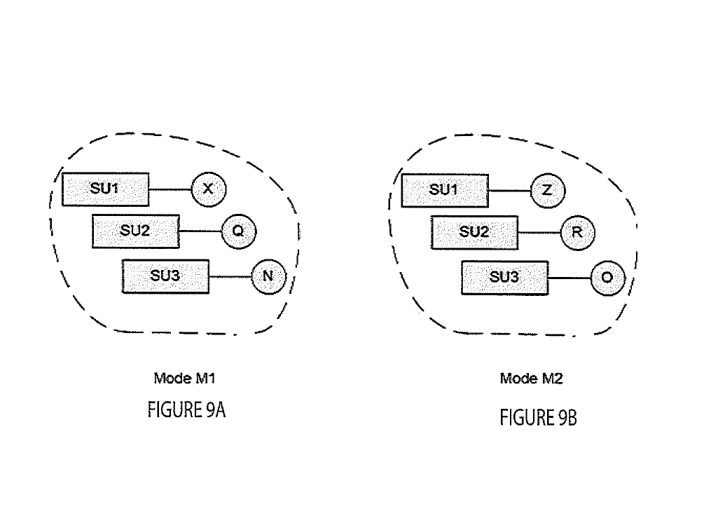

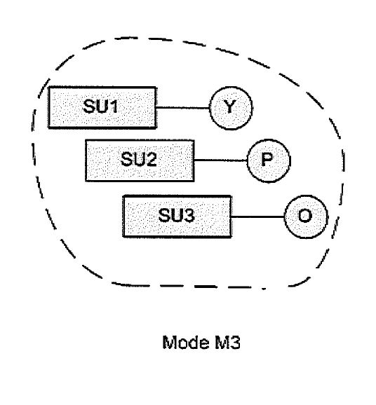

However, in other cases unit 203 may determine transition from one mode to another is not possible. FIGS. 9A and 9B show the states the subunits SU1, SU2, and SU3 need to have for the medical imaging system to be in modes M1 and M2, respectively and another mode M3 is defined by the subunits SU1, SU2, and SU3 being in states Y, P, and O respectively. If medical imaging system 25 is in mode M2, comparing the state transition requirements for modes M2 and M3 indicates for subunit SU1, the transition from state Z to state Y is possible via state X. But the transition from state R to state P is not possible for the subunit SU2. It is not necessary to check for the possibility of state transitions for subunit SU3, as at least one subunit SU2 cannot perform required state transitions. Therefore, system 25 cannot go directly from mode M2 to M3. System 10 presents state information to a user on display 19 in user friendly format as shown in FIG. 10. Specifically, FIG. 10 illustrates mode M3 requiring subunits SU1, SU2, and SU3 to be in states Y, P, and O respectively which is not directly accessible by transition from mode M2 as determined by operational state processor 29. Further, system 10 associates internal modes M1, M2, M3, for example, with corresponding descriptive names such as, ‘Normal Acquisition’, ‘Subtracted Acquisition’ and ‘Fluoroscopic Acquisition’.

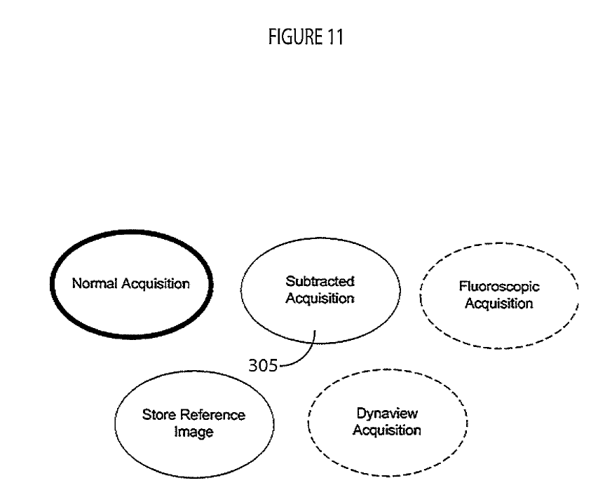

FIG. 11 shows medical imaging system operational state information with the corresponding descriptive names presented in user friendly understandable form as previously described in connection with FIG. 3. A user initiates an operational mode such as Subtracted Acquisition by selecting the Subtracted

Acquisition oval 305 and by selecting a ‘Show steps for this mode’ item from a drop-down context menu. Master unit 203 shows the list of action steps necessary for the user to perform to initiate an operational mode of system 25. In response to a user performing the steps, the ‘Subtracted Acquisition’ oval 305 is shown with a bold solid line like the ‘Normal Acquisition’ mode.

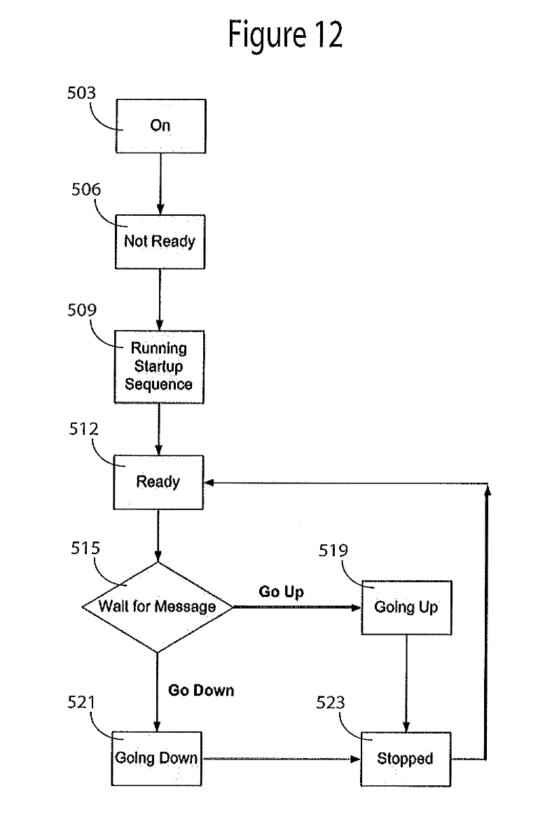

FIG. 12 shows a state machine diagram representing states and state transitions of a Stand Controller subunit controlling movement of an X-ray detector on a stand of X-ray imaging device 25. The stand controller controls the movement of the X-ray detector on a stand. Following switch on in step 503, the Stand Controller subunit enters a not ready state 506 and initiates a startup sequence in state 509. Upon completion of the startup sequence, the Stand Controller subunit enters a wait for message state 515 via a readiness state 512. In response to a user initiating a Go Up command to raise the stand, the Stand Controller subunit enters a Going Up state 519 until movement stops in state 523. Alternatively, in state 515, in response to a user initiating a Go Down command to lower the stand, the Stand Controller subunit enters a Going Down state 521 until movement stops in state 523. Following completion of movement in state 523, the Stand Controller subunit returns to the readiness state 512.

Master unit 203 provides a descriptive message list for each decision representation of a state machine and presents a message to a user on display 19 when a state is entered or a state transition is required. Also, Master unit 203 provides a descriptive message for individual states for each of the subunits of medical imaging system 25. Thus, unit 203 displays a message (“The stand controller is currently running the startup sequence. Please wait 10 s for it to complete”) in the Running Startup Sequence state 509 of FIG. 12, for example.

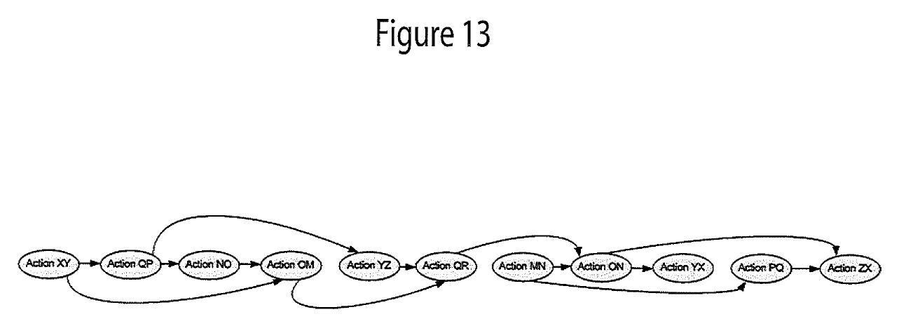

FIG. 13 shows actions and/or events that cause individual subunits to transition from one step to another in the form of a topologically sorted Directed Acyclic Graph (DAG) employed by master unit 203 (FIG. 2). Specifically, three subunits SU1, SU2 and SU3 of system 25 have the corresponding state diagrams shown in FIGS. 6, 7 and 8, respectively and Master unit 203 in one embodiment stores this information in the form of a sorted DAG involving actions including, ‘Action XY’, ‘Action YZ’, ‘Action YX’, ‘Action ZX’, ‘Action PQ’, ‘Action QR’, ‘Action QP’, ‘Action MN’, ‘Action NO’, ‘Action ON’, ‘Action OM’. In an operation example, a current system mode is M1 as described earlier, and a user desires medical imaging system 25 to transition to mode M2. As determined earlier, for this transition to occur, for subunit SU1 , a state transition is necessary from state

X to State Y as a result of Action XY, and from State Y to State Z as a result of Action YZ. Also, for subunit SU2, a state transition is necessary from State Q to State R as a result of Action QR. Likewise, for subunit SU3, necessary state transitions are from State N to State O as a result of Action NO. Thus, the applicable actions are, Action XY, Action YZ, Action QR and Action NO, Master unit 203 determines from the sorted DAG, the precedence of the four applicable actions out of the set of 11 possible actions. An arrow in the DAG going from one action such as Action XY to another such as Action QP means that the Action XY has to occur before Action QP. Master Unit 203 looks for the four applicable actions in the sorted DAG, and finds their order by going through the list shown in FIG. 13 from left to right. Thus, unit 203 determines the applicable action order is, Action XY, Action NO, Action YZ, Action QR. Master Unit 203 acquires and collates messages indicating the required actions and steps for medical imaging system 25 to transition from mode M1 to mode M2 from its stored message list and presents the list on display 19 to a user.

If a subunit is unable to go to a next applicable state in response to an action, due to an unforeseen or unavoidable error, the subunit sends a message indicating its current state, the intended next state that is unreachable due to the error, and a message describing the error in user understandable terms. This information is collated by Master Unit 203 and displayed to a user. In one embodiment, in a displayed image generated by display processor 31, a lower portion (e.g. one third) of the display area is reserved for textual information display such as detailed error messages presented to a user. This area has a vertical scroll bar and displays the most recent messages first. In the upper two thirds of the display image, the ovals (or other graphic symbols or text) representing system 25 state such as that of FIG. 3 are shown. Since there are many states that the system can be in, and there may not be enough space to show all the states, the top two thirds of the screen has a scroll bar which allows the user to go further down in the page if desired. The current state is shown on the top so that no scrolling is required. The system displays useful information, such as state information and the subunits participating in that state in response to a user hovering a cursor over an oval representing a current system state or mode.

A state transition from a current state to a user desired state for a given subunit may not be possible. This is the case previously described for the subunit SU2 for the mode transition from M2 to M3. In such a case, Master Unit 203 presents a descriptive message identifying state R for a subunit and indicates that that is the current state for SU2. Unit 203 determines from the state machine shown in FIG. 6, that there is no state transition possible from state R to state P and retrieves and displays the descriptive message for the destination state P in the textual information area.

In operation, following switch on, the subunits of the system send messages indicating their state information to Master Unit 203. Based on a stored list of subunits and associated states, Master Unit 203 shows system state in a diagram similar to that shown in FIG. 11 indicating one or none of the system modes is active. If none is active, a user selects the mode and chooses ‘Show steps for this mode’. The required steps are calculated as previously described and shown to a user. The user performs actions identified for the state transition required. If one of the modes is active, but the user wants to go to another mode, he chooses the new mode in the same way. Master Unit 203 calculates the next steps as described above, and shows the information in the textual message display area. If the user chooses a mode that is not possible, the Master Unit retrieves stored data in a state machine representation for the subunits and including a message list, and shows the information. This information indicates to the user why the mode transition is not possible. This message is valid in the current state of the system. As the state of the subunits change, the subunits notify the Master Unit, and the Master Unit repetitively updates the information tracking system state.

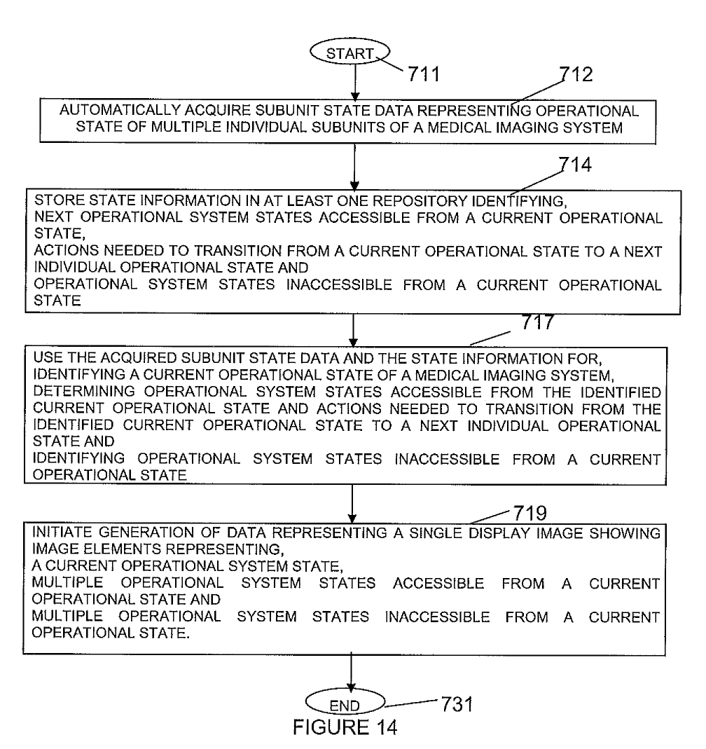

FIG. 14 shows a flowchart of a process used by user interface system 10 (FIG. 1) supporting user operation of a medical imaging system. In step 712, following the start at step 711 acquisition processor 15 automatically acquires subunit state data representing operational state of a multiple individual subunits of a medical imaging system;. In step 714 processor 15 stores state information in at least one repository 17. The state information identifies, next operational system states accessible from a current operational state, actions needed to transition from a current operational state to a next individual operational state and operational system states inaccessible from a current operational state, The state information includes data comprising reasons a state is inaccessible from a current operational state and identifies actions needed to be taken by a user to control medical imaging system 25 to transition from a current operational state to a state inaccessible from a current operational state.

Operational state processor in step 717, uses the acquired subunit state data and the state information for, identifying a current operational state of a medical imaging system, determining operational system states accessible from the identified current operational state and actions needed to transition from the identified current operational state to a next individual operational state and identifying operational system states inaccessible from a current operational state. The actions comprise tasks a user needs to perform in controlling medical imaging system 25.

In step 719, display processor 31 initiates generation of data representing at least one display image (in one embodiment comprising a single display image) showing image elements representing, a current operational system state, multiple operational system states accessible from a current operational state and multiple operational system states inaccessible from a current operational state. In response to user selection of an image element representing a particular operational system state accessible from a current operational state, the display processor initiates generation of data representing a display image indicating, at least one of, (a) user actions required to control the medical imaging system to transition to the particular operational system state and (b) medical imaging system actions performed in transitioning to the particular operational system state. In response to user selection of an image element representing a particular operational system state inaccessible from a current operational state, the display processor initiates generation of data representing a display image indicating, at least one of, (a) user actions required to exit the current operational system state and control the medical imaging system to transition to the particular operational system state, (b) medical imaging system actions performed in transitioning to the particular operational system state and (c) reasons why the particular operational system state is inaccessible from the current operational system state. The process of FIG. 14 terminates at step 731.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and is conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a user interface processor and enabling user interaction with a processor or other device and associated data acquisition and processing functions.

The UI also includes an executable procedure or executable application. The executable procedure or executable application conditions the user interface processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

The system and processes of FIGS. 1-14 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The system is usable in a variety of different fields where the system internally has state, and where the system can guide the user into making specific choices. Further, the processes and applications may, in alternative embodiments, be located on one or more (e.g., distributed) processing devices on a network linking the units of FIG. 1. Any of the functions and steps provided in FIGS. 1-14 may be implemented in hardware, software or a combination of both.

What is claimed is:

1. A user interface system supporting user operation of a medical imaging system comprising a plurality of subunits, comprising:
an acquisition processor for automatically acquiring subunit state data representing operational state of a plurality of individual subunits of a medical imaging system;
at least one repository of state information identifying,
next operational system states accessible from a current operational state,
actions needed to transition from a current operational state to a next individual operational state and
operational system states inaccessible from a current operational state; and
an operational state processor for using the acquired subunit state data and the state information for,
identifying a current operational state of a medical imaging system,
determining operational system states accessible from the identified current operational state and actions needed to transition from the identified current operational state to a next individual operational state and
identifying operational system states inaccessible from a current operational state.

2. A system according to claim 1, wherein
said actions comprise tasks a user needs to perform in controlling said medical imaging system.

3. A system according to claim 1, wherein
said state information includes data comprising reasons a state is inaccessible from a current operational state.

4. A system according to claim 3, wherein
said state information identifies actions needed to be taken by a user to control said medical imaging system to transition from a current operational state to a state inaccessible from a current operational state.

5. A system according to claim 1, including
a display processor for initiating generation of data representing at least one display image showing operational system states accessible from a current operational state and operational system states inaccessible from a current operational state.

6. A system according to claim 5, wherein
said at least one display image comprise a single display image.

7. A system according to claim I, including
a display processor for initiating generation of data representing a single display image showing image elements representing,
a current operational system state,
a plurality of operational system states accessible from a current operational state and
a plurality of operational system states inaccessible from a current operational state.

8. A system according to claim 7, wherein
in response to user selection of an image element representing a particular operational system state accessible from a current operational state, said display processor initiates generation of data representing a display image indicating, at least one of, (a) user actions required to control said medical imaging system to transition to said particular operational system state and (b) medical imaging system actions performed in transitioning to said particular operational system state.

9. A system according to claim 7, wherein
in response to user selection of an image element representing a particular operational system state inaccessible from a current operational state, said display processor initiates generation of data representing a display image indicating, at least one of (a) user actions required to exit said current operational system state and control said medical imaging system to transition to said particular operational system state and (b) medical imaging system actions performed in transitioning to said particular operational system state.

10. A system according to claim 7, wherein
in response to user selection of an image element representing a particular operational system state inaccessible from a current operational state, said display processor initiates generation of data representing a display image indicating reasons why said particular operational system state is inaccessible from said current operational system state.

11. A user interface system supporting user operation of a medical imaging system comprising a plurality of subunits, comprising:
an acquisition processor for automatically acquiring subunit state data representing operational state of a plurality of individual subunits of a medical imaging system;
at least one repository of state information identifying,
next operational system states accessible from a current operational state,
actions needed to transition from a current operational state to a next individual operational state and
operational system states inaccessible from a current operational state; and
a display processor for using the acquired subunit state data and the state information for initiating generation of data representing a single display image showing image elements representing,
a current operational system state.
a plurality of operational system states accessible from a current operational state and
a plurality of operational system states inaccessible from a current operational state.

12. A system according to claim 11, wherein
in response to user selection of an image element representing a particular operational system state accessible from a current operational state, said display processor initiates generation of data representing a display image indicating user actions required to control said medical imaging system to transition to said particular operational system state.

13. A system according to claim 12, wherein
in response to user selection of an image element representing a particular operational system state inaccessible from a current operational state, said display processor initiates generation of data representing a display image indicating reasons why said particular operational system state is inaccessible from said current operational system state.

14. A system according to claim 11, including
an operational state processor for using the acquired subunit state data and the state information for,
identifying a current operational state of a medical imaging system,
determining operational system states accessible from the identified current operational state and actions needed to transition from the identified current operational state to a next individual operational state and
identifying operational system states inaccessible from a current operational state.

15. A method of providing a user interface system supporting user operation of a medical imaging system comprising a plurality of subunits, comprising the activities of:
automatically acquiring subunit state data representing operational state of a plurality of individual subunits of a medical imaging system;
storing state information in at least one repository, said state information identifying,
next operational system states accessible from a current operational state,
actions needed to transition from a current operational state to a next individual operational state and
operational system states inaccessible from a current operational state; and
using the acquired subunit state data and the state information for,
identifying a current operational state of a medical imaging system,
determining operational system states accessible from the identified current operational state and actions needed to transition from the identified current operational state to a next individual operational state and
identifying operational system states inaccessible from a current operational state.

16. A method according to claim 15, including the activity of
initiating generation of data representing a single display image showing image elements representing,
a current operational system state.
a plurality of operational system states accessible from a current operational state and
a plurality of operational system states inaccessible from a current operational state.
